(19) United States
(12) Patent Application Publication
(10) Pub. No.: US 2007/0139152 A1
(43) Pub. Date: Jun. 21, 2007

(54) Balanced transformer having an auxiliary coil

(76) Inventors: Chun-Kong Chan, Hsi Chih City (TW); Jeng-Shong Wang, Hsin Chuang (TW); Chi-Ming Yang, Hsin Chuang (TW); Jin-Jiun Jiang, Hsin Chuang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/312,737

(22) Filed: Dec. 21, 2005

(51) Int. Cl. H01F 27/30

(52) U.S. Cl. 336/208

(57) ABSTRACT

A balanced transformer having an auxiliary coil has a bobbin, a balanced coil set, a detective coil, and an iron core set. The balanced coil set and the detective coil is wound onto the bobbin. The iron core set penetrates through the bobbin. The balanced transformer can be used in a driving circuit of a backlight module of an LCD device. The balanced coil set is electrically connected to CCFLs of the backlight module. The detective coil is electrically connected to a protection circuit of the backlight module. When currents respectively passing through the CCFLs are not equal to each other, two ends of the detective coil induct a voltage to form a protection feedback signal transmitted to the protection circuit. Therefore, the balanced transformer is capable of detecting an unusual current, so as to further protect the balanced transformer and the driving circuit of the backlight module.

### BACKGROUND OF THE INVENTION

1. Field of the Invention

The present invention relates to a balanced transformer, and more particularly, to a balanced transformer having an auxiliary coil, which can be used in a driving circuit of a backlight module of an LCD (liquid crystal display) device.

2. Background of the Invention

CCFLs (Cold Cathode Fluorescent Lamps) are the standard light sources of a backlight module for an LCD (liquid crystal display) device. A large LCD device has to have two or more CCFLs to have sufficient brightness. Currents respectively passing through the CCFLs have to be equal to ensure that the brightness of the LCD device is uniform. Therefore, a balanced transformer is used in a driving circuit of the backlight module to ensure that the currents respectively passing through the CCFLs are equal.

Referring to FIG. 1 and FIG. 2, a conventional balanced transformer includes a bobbin 95, a first coil 91, a second coil 92, and an iron core set 94. The first coil 91 and the second coil 92 are wound onto the bobbin 95. The iron core set 94 penetrates through the bobbin 95.

It is known from Lenz's law that

$$V 1 = L 1 \frac{ⅆ i}{ⅆ t} - M \frac{ⅆ i}{ⅆ t} ,$$

and

$$V 2 = L 2 \frac{ⅆ i}{ⅆ t} - M \frac{ⅆ i}{ⅆ t} .$$

The voltage V1 of the first coil 91 and the voltage V2 of the second coil 92 cancel out each other to achieve a balanced effect upon currents. As such, currents respectively passing through the CCFLs connected to the balanced transformer are equal to each other. In other words, the currents respectively passing through the CCFLs are balanced.

The above conventional balanced transformer is capable of balancing the currents. However, the balanced transformer is unable to detect an unusual situation suddenly caused by the currents passing through the CCFLs. As a result, the balanced transformer and the driving circuit of the backlight module become damaged.

### SUMMARY OF THE INVENTION

The primary object of the invention is therefore to specify a balanced transformer having an auxiliary coil that enables the balanced transformer to detect an unusual current.

According to the invention, the object is achieved via a balanced transformer having an auxiliary coil. The balanced transformer comprises a bobbin, a balanced coil set, a detective coil, and an iron core set. The balanced coil set is wound onto the bobbin. The detective coil is wound onto the bobbin. The iron core set penetrates through the bobbin.

The balanced transformer can be used in a driving circuit of a backlight module of an LCD (liquid crystal display) device. The balanced coil set is electrically connected to the CCFLs (Cold Cathode Fluorescent Lamps) of the backlight module. The detective coil is electrically connected to a protection circuit of the backlight module. When currents respectively passing through the CCFLs are not equal to each other, two ends of the detective coil induct a voltage to form a protection feedback signal transmitted to the protection circuit. Therefore, the balanced transformer is able to detect an unusual current, so as to further protect the balanced transformer and the driving circuit of the backlight module.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention which will be described hereinafter and which will form the subject of the claims appended hereto.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is an exploded planar view of a balanced transformer of the prior art;

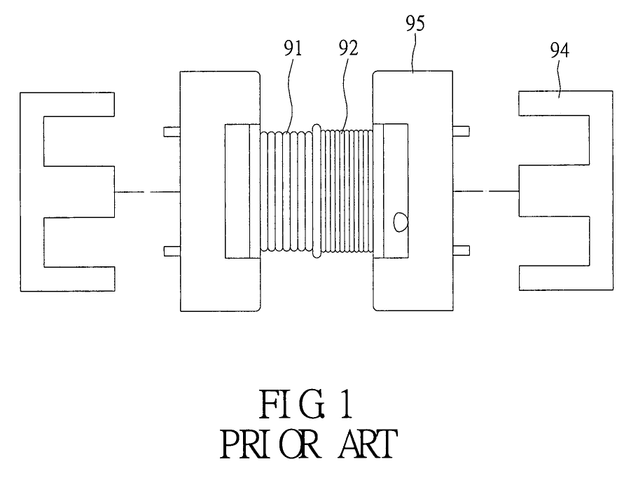

FIG. 2 is a top view of a bobbin of a balanced transformer of the prior art;

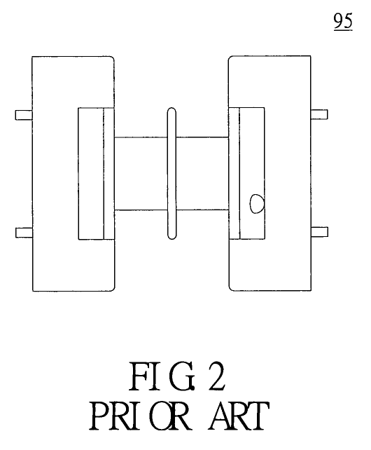

FIG. 3 is an exploded planar view of a balanced transformer having an auxiliary coil of the present invention;

FIG. 4 is a top view of a bobbin of a balanced transformer having an auxiliary coil of the present invention;

FIG. 5 is a front view of a bobbin of a balanced transformer having an auxiliary coil of the present invention;

FIG. 6 is a perspective view of a bobbin of a balanced transformer having an auxiliary coil of the present invention; and

FIG. 7 is an exploded planar view of another embodiment of a balanced transformer having an auxiliary coil of the present invention.

### DETAILED DESCRIPTION OF THE EMBODIMENTS

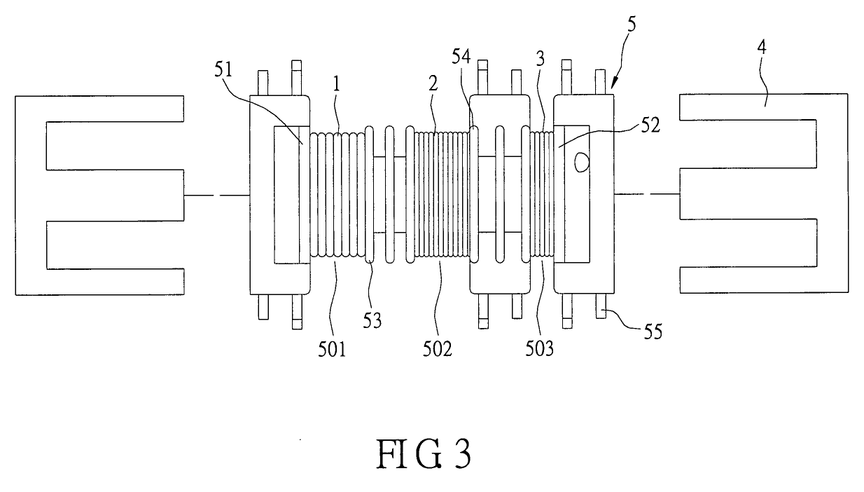

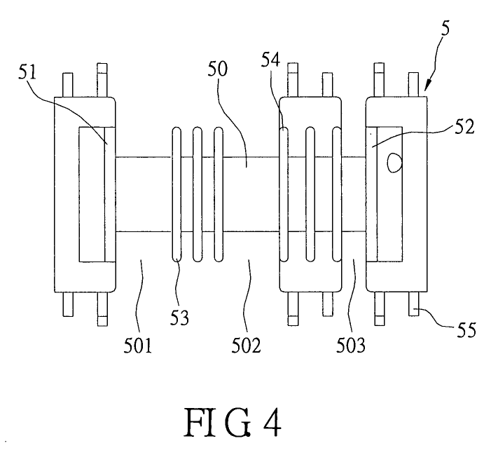

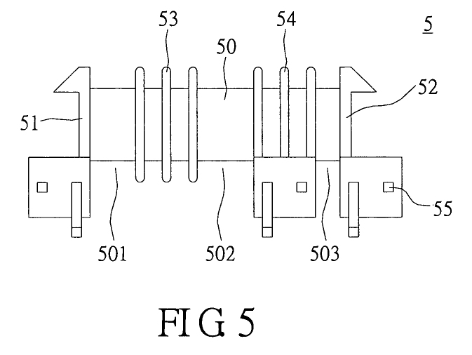

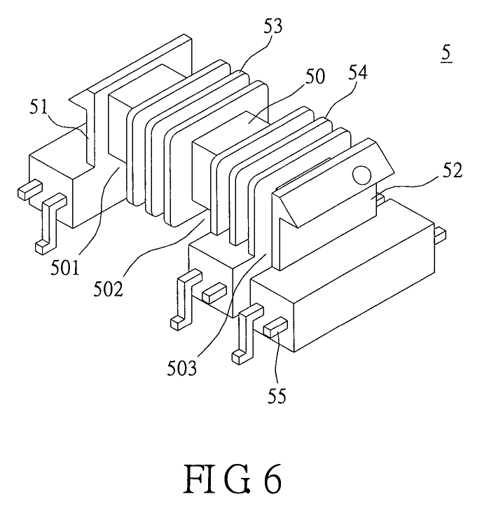

Referring to FIGS. 3-6, the present invention provides a balanced transformer having an auxiliary coil. The balanced transformer comprises a bobbin 5, a balanced coil set, a detective coil 3, and an iron core set 4.

The bobbin 5 has a tubular body 50, a first side wall 51, a second side wall 52, at least one first partition 53, and at least one second partition 54. The first side wall 51 and the second side wall 52 are respectively connected to two ends of the tubular body 50. The at least one first partition 53 and the at least one second partition 54 are connected to the tubular body 50 and located between the first side wall 51 and the second side wall 52. In this embodiment, the bobbin 5 has a plurality of first partitions 53 and a plurality of second partitions 54. Two adjacent first partitions 53 and two adjacent second partitions 54 each form an interval therebetween, so as to satisfy an electric safety requirement. The bobbin 5 can be integrally formed in one piece or assembled from a number of separated components.

The bobbin 5 has a first coil-winding area 501, a second coil-winding area 502, and a third coil-winding area 503. The first coil-winding area 501 is formed between the first side wall 51 and the at least one first partition 53. The second coil-winding area 502 is formed between the at least one first partition 53 and the at least one second partition 54. The third coil-winding area 503 is formed between the at least one second partition 54 and the second side wall 52. As such, in this embodiment, the second coil-winding area 502 is located between the first coil-winding area 501 and the third coil-winding area 503.

The balanced coil set is wound onto the bobbin 5. As shown in FIG. 3, the balanced coil set includes a first coil 1 and a second coil 2. The first coil 1 and the second coil 2 are a primary coil and a secondary coil, respectively. Alternatively, the first coil 1 and the second coil 2 are a secondary coil and a primary coil, respectively. The first coil 1 is wound onto the tubular body 50 of the bobbin 5 and located in the first coil-winding area 501. The second coil 2 is wound onto the tubular body 50 of the bobbin 5 and located in the second coil-winding area 502.

The detective coil 3 is wound onto the tubular body 50 of the bobbin 5 and located in the third coil-winding area 503, so as to be an auxiliary coil.

In addition, the bobbin 5 has a plurality of terminals 55 for being wound by distal ends of the first coil 1, distal ends of the second coil 2, and distal ends of the detective coil 3, respectively.

The iron core set 4 penetrates through the bobbin 5 so as to be a path for magnetic flux. The iron core set 4 can be composed of two E-type iron cores, one E-type iron core and one I-type iron core, two U-type iron cores, one U-type iron core and one I-type iron core, or two L-type iron cores. In this embodiment, the iron core set 4 is composed of two E-type iron cores. A central post (not labeled) of each of the E-type iron cores penetrates into the tubular body 50 of the bobbin 5.

The balanced transformer can be used in a driving circuit of a backlight module of an LCD (liquid crystal display) device and is electrically connected to a main transformer of the driving circuit of backlight module. The first coil 1 and the second coil 2 of the balanced coil set are respectively and electrically connected to two pieces of CCFLs (Cold Cathode Fluorescent Lamps) of the backlight module. The detective coil 3 is electrically connected to a protection circuit of the backlight module.

When currents respectively passing through the CCFLs are equal to each other, or in other words, when currents respectively passing through the CCFLs are balanced, two ends of the detective coil 3 do not induct a voltage.

When currents respectively passing through the CCFLs are not equal to each other, or in other words, when currents respectively passing through the CCFLs are unbalanced, a magnetomotive force generated by the current passing through the first coil 1 and another magnetomotive force generated by the other current passing through the second coil 2 are not equal to each other, so that the iron core set 4 generates a mass of magnetic flux. The magnetic flux cuts the detective coil 3, so that two ends of the detective coil 3 induct a voltage to form a protection feedback signal transmitted to the protection circuit. Therefore, the balanced transformer has a function of detecting an unusual current, so as to further protect the balanced transformer and the driving circuit of the backlight module.

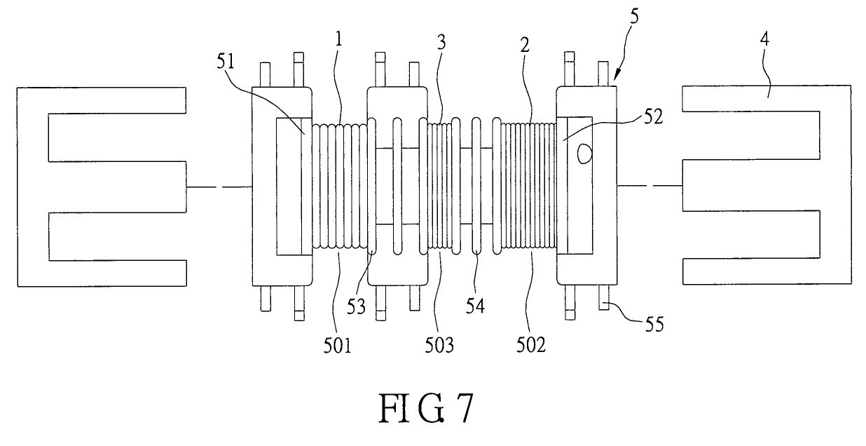

FIG. 7 shows another embodiment of a balanced transformer having an auxiliary coil of the present invention. The difference between this embodiment and the previous embodiment is the arrangement of the first coil-winding area 501, the second coil-winding area 502, and the third coil-winding area 503 of the bobbin 5. The first coil-winding area 501 is formed between the first side wall 51 and the at least one first partition 53. The second coil-winding area 502 is formed between the second side wall 52 and the at least one second partition 54. The third coil-winding area 503 is formed between the at least one first partition 53 and the at least one second partition 54. As such, in this embodiment, the third coil-winding area 503 is located between the first coil-winding area 501 and the second coil-winding area 502. Therefore, it is known from FIG. 3 and FIG. 7 that the detective coil 3 can be wound onto any available position of the bobbin 5.

In addition, by changing the shape of the iron core set 4 and by using the theory of a closed path for magnetic flux of the iron core set 4, a plurality of bobbins 5 each wound by the first coil 1, the second coil 2, and the detective coil 3 can be integrated together, so as to balance a number of CCFLs. Therefore, the balanced transformer can be expanded according to the requirements of the LCD device.

As indicated above, the balanced transformer having an auxiliary coil of the present invention has the following advantages:

1. When currents respectively passing through the CCFLs are not equal to each other, two ends of the detective coil induct a voltage to form a protection feedback signal transmitted to the protection circuit. Therefore, the balanced transformer is able to detect an unusual current, so as to further protect the balanced transformer and the driving circuit of the backlight module.

2. By changing the shape of the iron core set and by using the theory of a closed path for magnetic flux of the iron core set, a plurality of bobbins each wound by the first coil, the second coil, and the detective coil can be integrated together, so as to balance a number of CCFLs.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A balanced transformer having an auxiliary coil, comprising:
a bobbin;
a balanced coil set wound onto the bobbin;
a detective coil wound onto the bobbin; and
an iron core set penetrating through the bobbin.

2. The balanced transformer as claimed in claim 1, wherein the bobbin has a first coil-winding area, a second coil-winding area, and a third coil-winding area, the balanced coil set includes a first coil and a second coil, the first coil is wound onto the bobbin and located in the first coil-winding area, the second coil is wound onto the bobbin and located in the second coil-winding area, and the detective coil is wound onto the bobbin and located in the third coil-winding area.

3. The balanced transformer as claimed in claim 2, wherein the second coil-winding area is located between the first coil-winding area and the third coil-winding area.

4. The balanced transformer as claimed in claim 3, wherein the first coil and the second coil are a primary coil and a secondary coil, respectively.

5. The balanced transformer as claimed in claim 3, wherein the first coil and the second coil are a secondary coil and a primary coil, respectively.

6. The balanced transformer as claimed in claim 2, wherein the third coil-winding area is located between the first coil-winding area and the second coil-winding area.

7. The balanced transformer as claimed in claim 2, wherein the bobbin has a tubular body, a first side wall, a second side wall, at least one first partition, and at least one second partition, the first side wall and the second side wall are respectively connected to two ends of the tubular body, the at least one first partition and the at least one second partition are connected to the tubular body and located between the first side wall and the second side wall, the first coil-winding area is formed between the first side wall and the at least one first partition, the second coil-winding area is formed between the at least one first partition and the at least one second partition, and the third coil-winding area is formed between the at least one second partition and the second side wall.

8. The balanced transformer as claimed in claim 7, wherein the first coil and the second coil are a primary coil and a secondary coil, respectively.

9. The balanced transformer as claimed in claim 7, wherein the first coil and the second coil are a secondary coil and a primary coil, respectively.

10. The balanced transformer as claimed in claim 2, wherein the bobbin has a tubular body, a first side wall, a second side wall, at least one first partition, and at least one second partition, the first side wall and the second side wall are respectively connected to two ends of the tubular body, the at least one first partition and the at least one second partition are connected to the tubular body and located between the first side wall and the second side wall, the first coil-winding area is formed between the first side wall and the at least one first partition, the second coil-winding area is formed between the second side wall and the at least one second partition, and the third coil-winding area is formed between the at least one first partition and the at least one second partition.
